(19) United States
(12) Patent Application Publication
(10) Pub. No.: US 2011/0141393 A1
(43) Pub. Date: Jun. 16, 2011

(54) OPTICAL DEVICES

(75) Inventors: Sang-Pil HAN, Daejeon (KR); Young-Tak Han, Daejeon (KR); Sang Ho Park, Daejeon (KR); Jang Uk Shin, Daejeon (KR); Yongsoon Baek, Daejeon (KR)

(73) Assignee: ELECTRONICS AND TELECOMMUNICATIONS RESEARCH INSTITUTE, Daejeon (KR)

(21) Appl. No.: 12/832,457

(22) Filed: Jul. 8, 2010

(30) Foreign Application Priority Data
Dec. 15, 2009 (KR) 10-2009-0124861

(51) Int. Cl. G02F 1/13357; F21V 8/00

(52) U.S. Cl. 349/62; 362/551; 362/553; 362/555

(57) ABSTRACT

Provided is an optical device. The optical device includes an optical waveguide comprising a core surrounded by a cladding, a light source providing light to the optical waveguide, and an optics system disposed between the optical waveguide and the light source, the optics system focusing the light emitted from the light source into the core of the optical waveguide and a portion of the cladding adjacent to the core.

### CROSS-REFERENCE TO RELATED APPLICATIONS

This U.S. non-provisional patent application claims priority under 35 U.S.C. §119 of Korean Patent Application No. 10-2009-0124861, filed on Dec. 15, 2009, the entire contents of which are hereby incorporated by reference.

### BACKGROUND OF THE INVENTION

The present invention disclosed herein relates to optical devices, and more particularly, to optical devices that control a refractive index of an optical waveguide using light.

Generally, a waveguide type optical switch and a variable optical attenuator change a refractive index of an optical waveguide using a thermo-optic effect to realize a switching operation and an attenuation operation, respectively. At this time, a heater electrode is disposed on a surface of an upper cladding of an optical waveguide. When an input/output terminal is expanded into an N×M matrix form having a large scale, since a large number of heater electrodes should cross a surface of the optical waveguide, losses such as a polarization dependent loss (PDL) and a propagation loss increase. In addition, it is difficult to perform wire bonding on the heater electrodes. Also, to reduce such the losses, in case where the upper cladding has a thicker thickness, power consumption increases.

In an external cavity laser (ECL) device of a tunable laser, a metal pattern electrode of a grating is formed on a surface of an upper cladding of an optical waveguide, and an electrical voltage and current applied to the metal pattern electrode are regulated to use a principle in which a wavelength is varied. At this time, since the regulated voltage and current are uniformly applied to the whole grating, only a total refractive index is changed without changing a period and gap of the grating. Thus, the above-described method has a limitation that variableness of a wideband-wavelength is limited.

### SUMMARY OF THE INVENTION

The present invention provides an optical device in which losses such as a polarization dependent loss and a propagation loss and power consumption are reduced and a wideband-wavelength is variable.

The object of the present invention is not limited to the aforesaid, but other objects not described herein will be clearly understood by those skilled in the art from descriptions below.

Embodiments of the present invention provide optical devices. The optical devices include: an optical waveguide comprising a core surrounded by a cladding; a light source providing light to the optical waveguide; and an optics system disposed between the optical waveguide and the light source, the optics system focusing the light emitted from the light source into the core of the optical waveguide and a portion of the cladding adjacent to the core.

In some embodiments, the light source may include at least one of a laser diode (LD), a light emitting diode (LED), an organic light emitting diode (OLED), a resonant cavity light emitting diode (RCLED), a vertical cavity surface emitting laser (VCSEL), and combinations thereof. The light may have a wavelength that changes refractive indexes of the core and the cladding.

In other embodiments, the light source may include a liquid crystal device. The liquid crystal device may include: a backlight unit; a thin film transistor array; a liquid crystal; and a color filter.

In still other embodiments, the backlight unit may include at least one of a laser diode (LD), a light emitting diode (LED), an organic light emitting diode (OLED), a resonant cavity light emitting diode (RCLED), a vertical cavity surface emitting laser (VCSEL), and combinations thereof.

In even other embodiments, the color filter may determine a wavelength that changes refractive indexes of the core and the cladding.

In yet other embodiments, the light source may have an N×M array (here, N and M are a natural number).

In further embodiments, the optics system may include at least one of a convex lens, a concave lens, a hemispherical lens, a cylindrical lens, and combinations thereof.

In still further embodiments, the optical waveguide may be formed of a photosensitive material.

In even further embodiments, the optical waveguide may include a straight optical waveguide.

In yet further embodiments, the optical waveguide may include a curved optical waveguide.

In much further embodiments, the optical waveguide may include a Y-branch optical waveguide.

In still much further embodiments, the optical waveguide may include a Mach-Zehnder optical waveguide.

In even much further embodiments, the optical waveguide may include a grating optical waveguide.

In yet much further embodiments, the optical waveguide may be disposed on a substrate.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a schematic cross-section view of an optical device according to an embodiment of the present invention;

FIG. 2 is a schematic cross-section view of an optical device according to another embodiment of the present invention; and

FIGS. 3 to 6 are schematic top views of optical devices according to embodiments of the present invention.

### DETAILED DESCRIPTION OF PREFERRED EMBODIMENTS

Hereinafter, embodiments of the present invention will be described in detail with reference to accompanying drawings. Objects, other objects, characteristics and advantages of the present invention will be easily understood from an explanation of a preferred embodiment that will be described in detail below by reference to the attached drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Like reference numerals refer to like elements throughout.

In the following description, the technical terms are used only for explain a specific exemplary embodiment while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components. It will be understood that when an element such as a layer, film, region, or substrate is referred to as being “on” another element, it can be directly on the other element or intervening elements may also be present.

Additionally, the embodiment in the detailed description will be described with cross-section views as ideal exemplary views of the present invention. In the figures, the dimensions of layers and regions are exaggerated for clarity of illustration. Accordingly, shapes of the exemplary views may be modified according to manufacturing techniques and/or allowable errors. Therefore, the embodiments of the present invention are not limited to the specific shape illustrated in the exemplary views, but may include other shapes that may be created according to manufacturing processes. For example, although an etched region is illustrated as being angled, it may also be rounded. Areas exemplified in the drawings have general properties, and are used to illustrate a specific shape of a semiconductor package region. Thus, this should not be construed as limited to the scope of the present invention.

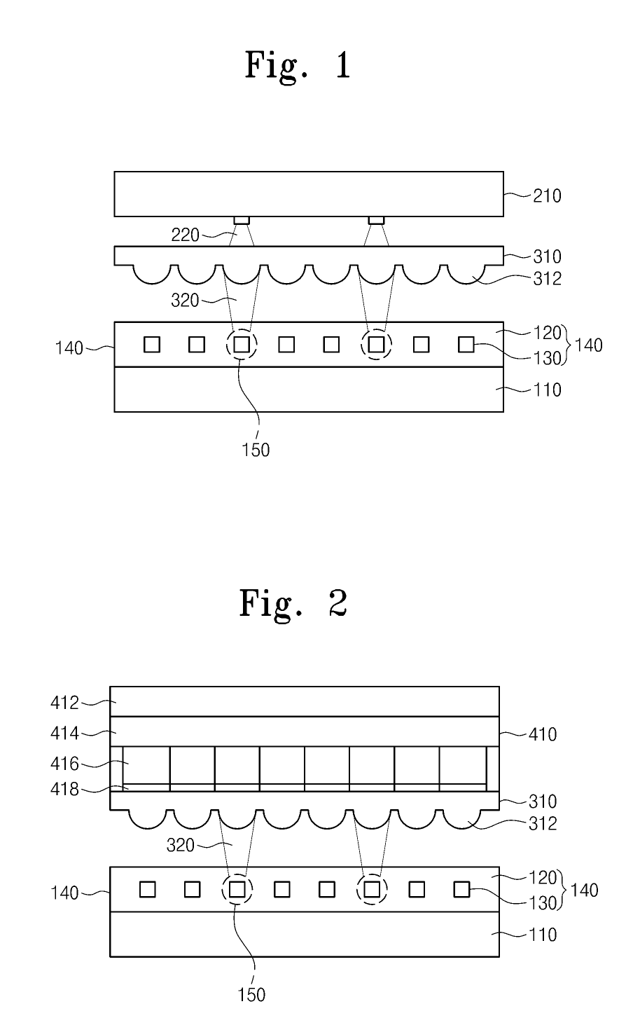

FIG. 1 is a schematic cross-section view of an optical device according to an embodiment of the present invention.

Referring to FIG. 1, an optical device includes an optical waveguide 140, a light emitting device 210, and an optics system 310.

The optical waveguide 140 may be disposed on a substrate 110. The optical waveguide 140 may include a cladding 120 and a core 130 surrounded by the cladding 120 on the substrate 110. The optical waveguide 140 may be formed of a photosensitive material that can generate a thermo-optic effect or a photo-optic effect in response to light 220 having a predetermined wavelength band.

The light emitting device 210 supplies the light 220 to the optical waveguide 140. The light 220 emitted from the light emitting device 210 may have a wavelength having a predetermined band in which refractive indexes of the cladding 120 and the core 130 of the optical waveguide 140 are changeable. The light emitting device 210 may include a laser diode (LD), a light emitting diode (LED), an organic light emitting diode (OLED), a resonant cavity light emitting diode (RCLED), and a vertical cavity surface emitting laser (VCSEL). The light emitting device 210 may have an N×M array (here, N and M are a natural number).

The optics system 310 may be disposed between the optical waveguide 140 and the light emitting device 210. The optics system 310 may supply the light 220 emitted from the light emitting device 210 to a refractive index change region 150 including the core 130 and a portion of the cladding 120 adjacent to the core 130 of the optical waveguide 140 in a form of focused light 320. The optics system 310 may include a lens 312 for focusing the light 220 emitted from the light emitting device 210 into the refractive index change region 150. The lens 312 may include at least one of a convex lens, a concave lens, a hemispherical lens, a cylindrical lens, and combinations thereof.

The optical device according to an embodiment of the present invention converts the light 220 having a predetermined wavelength band and emitted from the light emitting device 210 into the focused light 320 through the optics system 310. The focused light 320 generates the thermo-optic effect or the photo-optic effect in response to the refractive index change region 150 including the core 130 and a portion of the cladding 120 adjacent to the core 130 of the optical waveguide 140 to change the refractive index of the optical waveguide 140. Thus, since the refractive index of the optical waveguide 140 is controlled by the light 220, the optical device may perform the switching, attenuation, and variable wavelength functions.

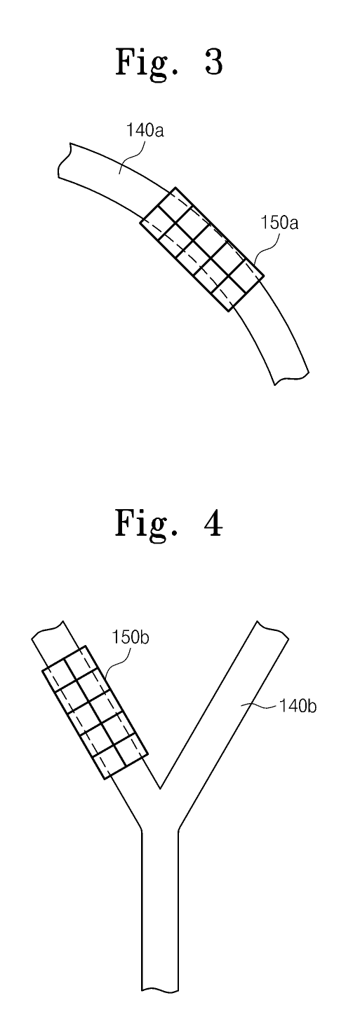

FIG. 2 is a schematic cross-section view of an optical device according to another embodiment of the present invention.

Referring to FIG. 2, an optical device includes an optical waveguide 140, a liquid crystal device 410, and an optics system 310.

The optical waveguide 140 may be disposed on a substrate 110. The optical waveguide 140 may include a cladding 120 and a core 130 surrounded by the cladding 120 on the substrate 110. The optical waveguide 140 may be formed of a photosensitive material that can generate a thermo-optic effect or a photo-optic effect in response to light 220 having a predetermined wavelength band.

The liquid crystal device 410 may supply light to the optical waveguide 140. The liquid crystal device 410 may include a polarization sheet (not shown), a backlight unit 412, a thin film transistor array (TFT array) 414, and a liquid crystal 416, similar to a liquid crystal display (LCD) panel. Unlike a typical liquid crystal display, the liquid crystal device 410 may include a color filter 418 for determining such that the light 220 emitted from the liquid crystal device 410 has a predetermined wavelength band in which refractive indexes of the core 130 and the cladding 120 of the optical waveguide 140. The backlight unit 412 of the liquid crystal device 410 may include an LD, an LED, an OLED, a RCLED, and a VCSEL. The liquid crystal device 410 may have an N×M array (here, N and M are a natural number).

The optics system 310 may be disposed between the optical waveguide 140 and the liquid crystal device 410. The optics system 310 may supply the light 220 having a predetermined wavelength band and emitted from the liquid crystal device 410 to a refractive index change region 150 including the core 130 140 and a portion of the cladding 120 adjacent to the core 130 of the optical waveguide 140 in a form of focused light 320. The optics system 310 may include a lens 312 for focusing the light 220 emitted from the liquid crystal device 410 into the refractive index change region 150 of the optical waveguide 140. The lens 312 may include at least one of a convex lens, a concave lens, a hemispherical lens, a cylindrical lens, and combinations thereof.

The optical device according to another embodiment of the present invention converts the light 220 having a predetermined wavelength band and emitted from the liquid crystal device 410 into the focused light 320 through the optics system 310. The focused light 320 generates the thermo-optic effect or the photo-optic effect in response to the refractive index change region 150 including the core 130 and a portion of the cladding 120 adjacent to the core 130 of the optical waveguide 140 to change the refractive index of the optical waveguide 140. Thus, since the refractive index of the optical waveguide 140 is controlled by the light 220, the optical device may perform the switching, attenuation, and variable wavelength functions.

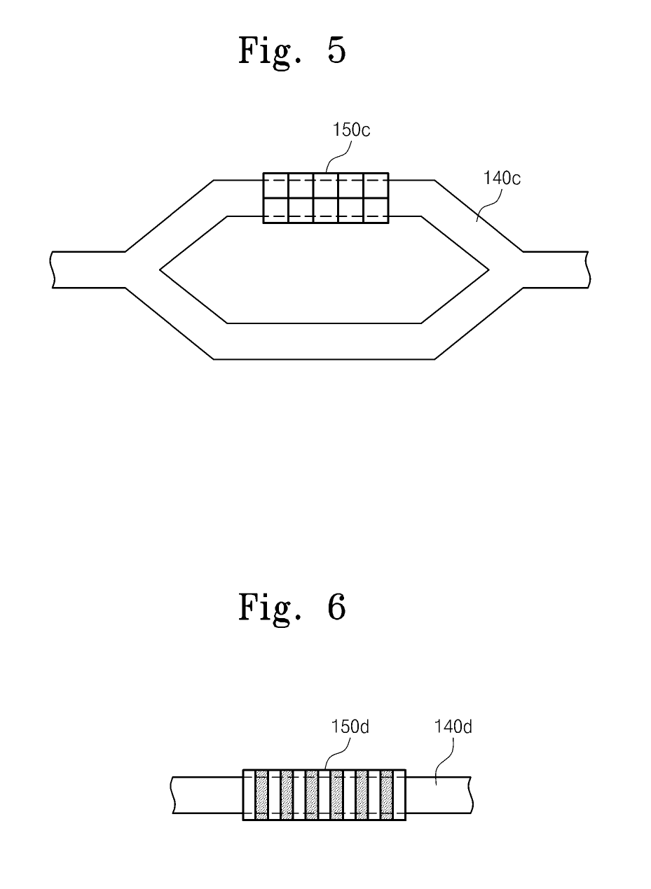

FIGS. 3 to 6 are schematic top views of optical devices according to embodiments of the present invention.

Referring to FIG. 3, an optical device may include a curved optical waveguide 140a. When light having a predetermined wavelength band and emitted from a light source (see reference numeral 210 of FIG. 1 or reference numeral 410 of FIG. 2) is focused into a refractive index change region pattern 150a of the curved optical waveguide 140a, a refractive index of the curved optical waveguide 140a is changed. At this time, an optical signal may be propagated at the curved optical waveguide 140a, or the propagated optical signal may be intercepted. Unlike FIG. 3, a straight optical waveguide, but the curved optical waveguide 140a may have the same phenomena.

Referring to FIG. 4, the optical device may include a Y-branch optical waveguide 140b. When light having a predetermined wavelength band and emitted from the light source is focused into a refractive index change region pattern 150b of one side optical waveguide of the Y-branch optical waveguide 140b, a refractive index of the one side optical waveguide of the Y-branch optical waveguide 140b is changed. At this time, an optical signal propagated along an input optical waveguide proceeds along only either side optical waveguide of the Y-branch optical waveguide 140b.

When the Y-branch optical waveguide 140b having such a switching function constitutes an N×M waveguide type optical device, an optical loss and power consumption may be significantly reduced when compared to a typical optical device including a heater electrode having a metal pattern shape on a surface of an upper cladding of an optical waveguide.

Referring to FIG. 5, the optical device may include a Mach-Zehnder optical waveguide 140c. When light having a predetermined wavelength band and emitted from the light source is focused into a refractive index change region pattern 150c of one side of the Mach-Zehnder optical waveguide 140c, a refractive index of the one side optical waveguide of the Mach-Zehnder optical waveguide 140c is changed. At this time, an optical signal propagated along an input optical waveguide affects an output optical waveguide because a phase of a parallel optical waveguide into which the light is focused is shifted. Thus, switching or attenuation phenomenon may occur.

When the Mach-Zehnder optical waveguide 140c having such a switching or an attenuation function constitutes an N×M waveguide type optical device, an optical loss and power consumption may be significantly reduced when compared to a typical optical device including a heater electrode having a metal pattern shape on a surface of an upper cladding of an optical waveguide.

Referring to FIG. 6, the optical device may include a grating optical waveguide 140d. The optical device may include a tunable laser further including an external cavity laser device. When light having a predetermined wavelength band and emitted from the light source is focused into a refractive index change region pattern 150d of the grating optical waveguide 140d, a refractive index of the grating optical waveguide 140d is changed. At this time, an optical signal propagated along an input optical waveguide and emitted from the external cavity laser device performs an external resonant function in a region in which the light is focused. As a result, only a predetermined wavelength is selected, and the selected wavelength is outputted to an output optical waveguide.

Thus, in the optical device including the grating optical waveguide 140d having such a variable wavelength function, an optical loss and power consumption may be significantly reduced when compared to a typical optical device including a heater electrode having a metal pattern shape on a surface of an upper cladding of an optical waveguide. Also, when the light source have an N×M array, it may be possible to optionally change a period and gap of a grating. In addition, since each of cells constituting the array has a different light intensity, a wideband-wavelength may be varied. Thus, the tunable laser may be improved in performance.

The optical device according to the embodiments of the present invention utilizes light to change the refractive index of the optical waveguide, unlike the typical optical device including the heater electrode having the metal pattern shape on the surface of the upper cladding of the optical waveguide. Thus, various losses such as a polarization dependent loss and a propagation loss may be further reduced. Also, a wire bonding process required for manufacturing the typical optical device including the heater electrode may be omitted. Thus, the optical device may be easily manufactured.

In addition, the optical device according to the embodiments of the present invention can change the refractive index of the optical waveguide, regardless of a thickness of the upper cladding, unlike that the upper cladding of the typical optical device including the heater electrode has a thicker thickness to reduce the above-described losses. Thus, the power consumption may be further reduced.

Furthermore, when the optical device according to the embodiments of the present invention is applied to the external cavity laser device of the tunable layer, the form of the light source and the light intensity may be optionally changed, unlike that the typical tunable laser including the metal pattern of the grating electrode does not optionally change the period and gap of the grating. Thus, since the wideband-wavelength is variable, the tunable laser may be improved in performance.

In addition, since the optical device according to the present invention may optionally change the form of the light source and the light intensity to change the refractive index of the optical waveguide and also have the N×M array, the optical device may be applied to the N×M waveguide type optical device having a large scale. Thus, the N×M waveguide type optical device having improved performance and large scale may be provided.

As described above, the optical device according to the present invention can utilize the light so as to change the refractive indexes of the core and the cladding of the optical waveguide, thereby reducing the various losses such as the polarization dependent loss and the propagation loss. As a result, the optical device having improved performance may be provided. Also, since the optical device can change the refractive indexes of the core and the cladding of the optical waveguide regardless of a thickness of the cladding surrounding the core, the optical device having low power consumption may be provided.

Since the optical device according to the present invention can optionally change the form of the light source and the light intensity to change the refractive indexes of the core and the cladding of the optical waveguide, the optical device can be applied to the N×M waveguide type optical device having a large scale. Thus, the N×M waveguide type optical device having improved performance and large scale may be provided. Also, since the wideband-wavelength is variable, the optical device in which a wideband-wavelength is variable may be provided.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical device comprising:
an optical waveguide comprising a core surrounded by a cladding;
a light source providing light to the optical waveguide; and
an optics system disposed between the optical waveguide and the light source, the optics system focusing the light emitted from the light source into the core of the optical waveguide and a portion of the cladding adjacent to the core.

2. The optical device of claim 1, wherein the light source comprises at least one of a laser diode (LD), a light emitting diode (LED), an organic light emitting diode (OLED), a resonant cavity light emitting diode (RCLED), a vertical cavity surface emitting laser (VCSEL), and combinations thereof.

3. The optical device of claim 2, wherein the light has a wavelength that changes refractive indexes of the core and the cladding.

4. The optical device of claim 1, wherein the light source comprises a liquid crystal device.

5. The optical device of claim 4, wherein the liquid crystal device comprises:
a backlight unit;
a thin film transistor array;
a liquid crystal; and
a color filter.

6. The optical device of claim 5, wherein the backlight unit comprises at least one of a laser diode (LD), a light emitting diode (LED), an organic light emitting diode (OLED), a resonant cavity light emitting diode (RCLED), a vertical cavity surface emitting laser (VCSEL), and combinations thereof.

7. The optical device of claim 5, wherein the color filter determines a wavelength that changes refractive indexes of the core and the cladding.

8. The optical device of claim 1, wherein the light source has an N×M array (here, N and M are a natural number).

9. The optical device of claim 1, wherein the optics system comprises at least one of a convex lens, a concave lens, a hemispherical lens, a cylindrical lens, and combinations thereof.

10. The optical device of claim 1, wherein the optical waveguide is formed of a photosensitive material.
